(19) United States
(12) Patent Application Publication
(10) Pub. No.: US 2025/0384630 A1
(43) Pub. Date: Dec. 18, 2025

(54) DATA PROCESSING APPARATUS AND METHOD

(71) Applicant: Sony Interactive Entertainment Inc., Tokyo (JP)

(72) Inventor: Alex Dixon, London (GB)

(21) Appl. No.: 19/229,659

(22) Filed: Jun. 5, 2025

(30) Foreign Application Priority Data
Jun. 12, 2024 (GB) 2408395.8

(51) Int. Cl. G06T 17/20; A63F 13/52

(52) U.S. Cl. CPC G06T 17/20; A63F 13/52

(57) ABSTRACT

A data processing apparatus comprising circuitry configured to: obtain data representing a boundary representing a virtual object in a virtual space; determine a signed distance field of the boundary in the virtual space; determine, by comparing a value of the signed distance field at each of a plurality of points of the virtual space with an output of one or more candidate signed distance functions at each of the plurality of points of the virtual space, a representative signed distance function representing the signed distance field; and output data representing the representative signed distance function.

### CROSS REFERENCE

The present application claims priority to United Kingdom (GB) Application No. 2408395.8, filed Jun. 12, 2024, the contents of which is incorporated by reference herein in its entirety for all purposes.

### FIELD OF THE DISCLOSURE

This disclosure relates to a data processing apparatus and method.

### BACKGROUND

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

In computer-generated graphical content (such as that of video games), the geometry of an object can be represented by a mesh. In a common example, the mesh is made up of a plurality of points in virtual 3D space with each point being connected to its three nearest points. The mesh thus comprises of a plurality of connected triangles (and may be referred to as a triangular mesh).

Complex and detailed geometry represented by a mesh can comprise many millions of triangles. Such a large number of triangles can become extremely computationally expensive to render. Such rendering is also very memory intensive.

There is therefore a desire to reduce the computational and memory expensive of rendering object geometries.

### SUMMARY

In an embodiment according to the present disclosure, a data processing apparatus includes circuitry configured to obtain data representing a boundary representing a virtual object in a virtual space; determine a signed distance field of the boundary in the virtual space; determine, by comparing a value of the signed distance field at each of a plurality of points of the virtual space with an output of one or more candidate signed distance functions at each of the plurality of points of the virtual space, a representative signed distance function representing the signed distance field; and output data representing the representative signed distance function.

The representative signed distance function can be defined by a final value of each of one or more function parameters and each candidate signed distance function can be defined by a candidate value of each of the one or more function parameters.

The representative signed distance function can represent a combination of one or more constituent signed distance functions.

The one or more function parameters can comprise one or more of a parameter indicating a number of each of a plurality of constituent signed distance function types, a scaling parameter of each constituent signed distance function, a rotation parameter of each constituent signed distance function and a translation parameter of each constituent signed distance function.

The circuitry can be configured to determine, based on an output of the representative signed distance function, if the representative signed distance function is under reconstructed with respect to the virtual object; and if the representative signed distance function is determined to be under reconstructed with respect to the virtual object, update the representative signed distance function by cloning one or more of the constituent signed distance functions.

The circuitry can be configured to determine, based on an output of the representative signed distance function, if the representative signed distance function is over reconstructed with respect to the virtual object; and if the representative signed distance function is determined to be over reconstructed with respect to the virtual object, update the representative signed distance function by splitting one or more of the constituent signed distance functions.

The circuitry can be configured to determine, based on an output of the representative signed distance function, if the representative signed distance function is over reconstructed with respect to the virtual object; and if the representative signed distance function is determined to be over reconstructed with respect to the virtual object, update the representative signed distance function by introducing an additional constituent signed distance function to be subtracted in the combination of one or more constituent signed distance functions.

In some embodiments, the representative signed distance function is determined using a machine learning model.

In some embodiments, an input to the machine learning model comprises a value of the signed distance field at each of the plurality of points of the virtual space; an output of the machine learning model comprises a value of each of the one or more function parameters for defining the representative signed distance function; and the circuitry is configured to: determine the output of each candidate signed distance function at each of the plurality of points of the virtual space using an output candidate value of each of the one or more function parameters; and perform back propagation using the output of each candidate signed candidate signed distance function at each of the plurality of points of the virtual space and the value of the signed distance field at each of the plurality of points of the virtual space.

The machine learning model can be a convolutional neural network.

The virtual space can be three-dimensional, 3D, virtual space and the boundary representing the virtual object is a mesh. The mesh can be a 3D triangular mesh.

In some embodiments, the virtual object is a video game object.

The present disclosure provides a computer-implemented data processing method comprising: obtaining data representing a boundary representing a virtual object in a virtual space; determining a signed distance field of the boundary in the virtual space; determining, by comparing a value of the signed distance field at each of a plurality of points of the virtual space with an output of one or more candidate signed distance functions at each of the plurality of points of the virtual space, a representative signed distance function representing the signed distance field; and outputting data representing the representative signed distance function.

The present disclosure provides a non-transitory computer-readable storage medium storing a program for controlling a computer to perform a data processing method comprising: obtaining data representing a boundary representing a virtual object in a virtual space; determining a signed distance field of the boundary in the virtual space; determining, by comparing a value of the signed distance field at each of a plurality of points of the virtual space with an output of one or more candidate signed distance functions at each of the plurality of points of the virtual space, a representative signed distance function representing the signed distance field; and outputting data representing the representative signed distance function.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIG. 2A schematically shows example components associated with the entertainment system;

FIG. 2B schematically shows an example data processing apparatus;

FIG. 3 schematically shows an example of a signed distance field;

FIGS. 4A and 4B schematically show an example of using a machine learning model to generate a representative signed distance function;

FIGS. 5A to 5C schematically show examples of underfill and overfill; and

FIG. 6 shows an example method.

Like reference numerals designate identical or corresponding parts throughout the drawings.

### DETAILED DESCRIPTION OF THE EMBODIMENTS

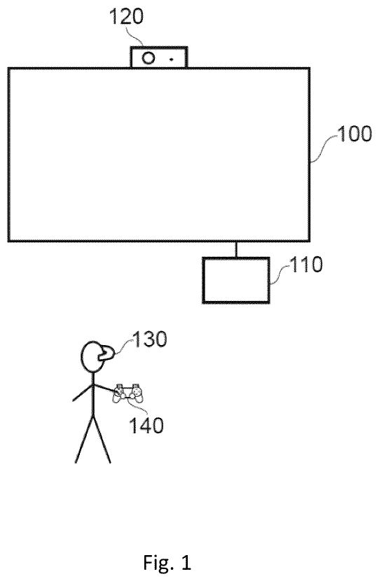

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

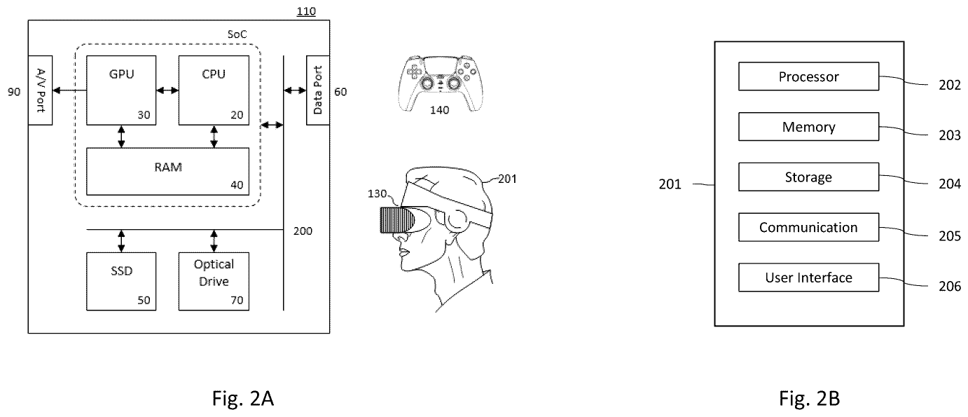

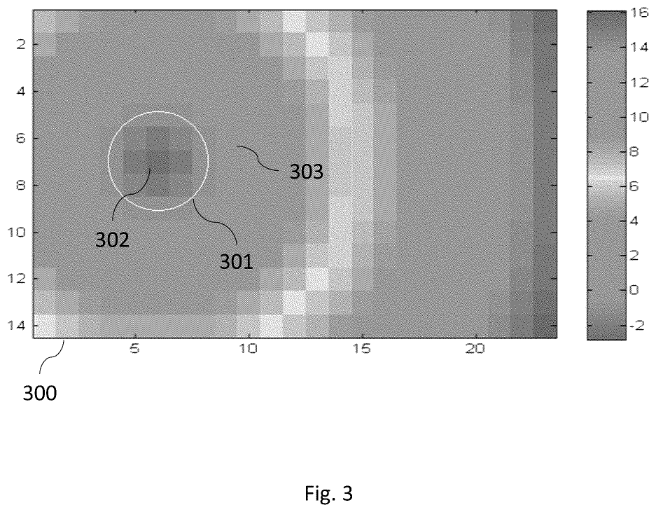

FIG. 2A shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows an example of another data processing apparatus 201 for generating a combined signed distance function in way(s) described below. Data processing apparatus 201 comprises a processor 202 for executing electronic instructions, a memory 203 (e.g. volatile memory) for storing the electronic instructions to be executed and electronic input and output information associated with the electronic instructions, a storage medium 204 (e.g. non-volatile memory) for long term (persistent) storage of information, a communication interface 205 for sending information to and/or receiving information from one or more other apparatuses and a user interface 206 (e.g. a touch screen, a non-touch screen, buttons, a keyboard and/or a mouse) for receiving commands from and/or outputting information to a user. Each of the processor 202, memory 203, storage medium 204, communication interface 205 and user interface 206 are implemented using appropriate circuitry, for example. The processor 202 controls the operation of each of the memory 203, storage medium 204, communication interface 205 and user interface 206.

The present technology takes, as an input, scene data formed of one or more triangular meshes. A machine learning model (such as a convolutional neural network) is then trained (e.g. by data processing apparatus 201) to generate a signed distance function (SDF) representing the scene data that can be evaluated to produce visually similar results. The evaluation of the generated SDF (e.g. by games console 110) requires a fraction of the computational and memory cost associated with the traditional rendering of a mesh. Different SDFs can also be used for different levels of detail (LODs) of a given object, thereby allowing objects to be rendered at an appropriate LOD quickly and efficiently.

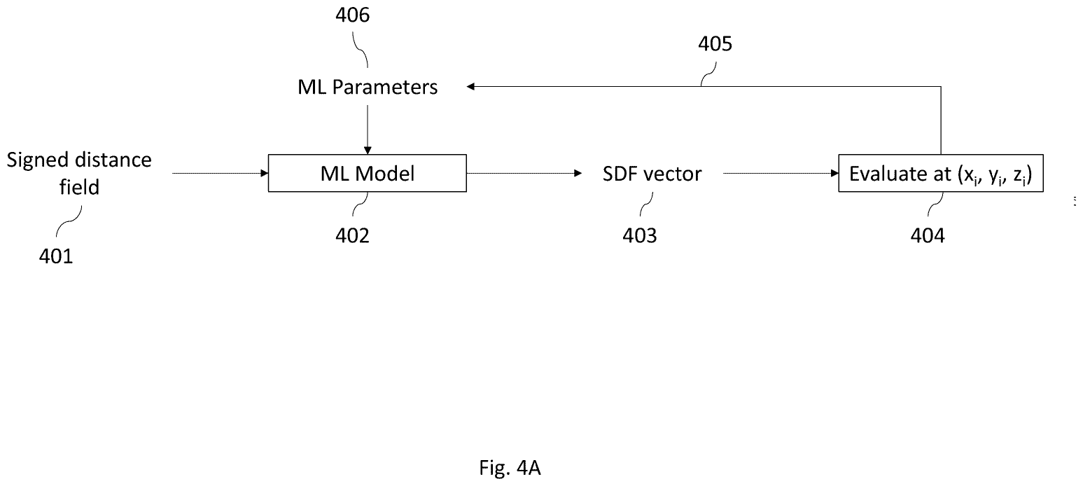

FIG. 3 shows a simple example of a signed distance field. FIG. 3 has been adapted from https://www.researchgate.net/figure/A-discrete-SDF-representation-of-a-circle-shape-zero-level-set-in-a-23x14-Cartesian_fig2_305997840. A signed distance field is a signed distance function evaluated at each of a plurality of predetermined points in a predetermined virtual space. On the other hand, a signed distance function is continuous, taking any set of input coordinates of the predetermined space (e.g. x, y and z coordinates in a three-dimensional, 3D, space) and providing an output value. A signed distance field may therefore be determined by evaluating a signed distance function at each of a plurality of predetermined points in a predetermined space. In this description, SDF refers to signed distance function (rather than a signed distance field).

An SDF represents the orthogonal distance between a given point in a predetermined space and a boundary of a set in the predetermined space. If the predetermined space is 3D, the boundary is a surface. With the present technology, a triangular mesh representing an object is such a surface. The triangular mesh can thus be uniquely represented by a corresponding SDF. In an example, the value of the SDF is negative inside the surface and positive outside the surface (or vice versa).

To illustrate an SDF in a simple way, the example of FIG. 3 shows a signed distance field for a circular boundary 301 in a 2D space 300. In a first region 302 within the boundary, the SDF (and thus the signed distance field) increases in magnitude (i.e. becomes more negative) the further the point from the boundary 301. In a second region 303 outside the boundary, the SDF (and thus the signed distance field) increases in magnitude (i.e. becomes more positive) the further the point from the boundary 301. The SDF is zero at points on the boundary itself. For the present technology, the same principle applies. The difference is that the space is a 3D (rather than 2D) space and the boundary 301 is a surface (rather than a curve), in particular the surface represented by the triangular mesh representing the geometry of the virtual object concerned. The signed distance field is thus a 3D signed distance field.

Such a 3D signed distance field is a 3D grid in which a cell at each position in the 3D grid has a scalar value (e.g. floating point or integer) representing the distance to the closest point on the surface defined by the triangular mesh. If the value d of a grid cell is positive then the position of the grid cell is outside the surface and d units away from the closest point on the surface. If the value d is negative then the position of the grid cell is outside the surface and d units away from the closest point on the surface. If the value d is 0 then it lies on the surface itself.

As previously mentioned, a signed distance field is different to a signed distance function. In particular, a signed distance field is a grid in which each cell of the grid is associated with a distance d to the closest point on the surface. A signed distance function, on the other hand, is a mathematical function which can be evaluated for any given set of coordinates [x, y, z] to obtain the distance d to the closest point on the surface. Sampling a signed distance field at [x, y, z] is semantically similar to evaluating a signed distance function at [x, y, z]. However, since the signed distance field is represented as a 3D grid of discrete values, it can become large to store in memory as it scales cubically with resolution. On the other hand, the signed distance function is more compact because it can be expressed as a mathematical function (e.g. as part of shader code compiled into assembly instructions). Using a signed distance function (which may be defined as an appropriate mathematical combination of simpler signed distance functions) in place of a large number of signed distance field values is thus desirable for reducing computational and memory expense. A problem, however, is how to determine a suitable signed distance function for the surface of any given virtual object.

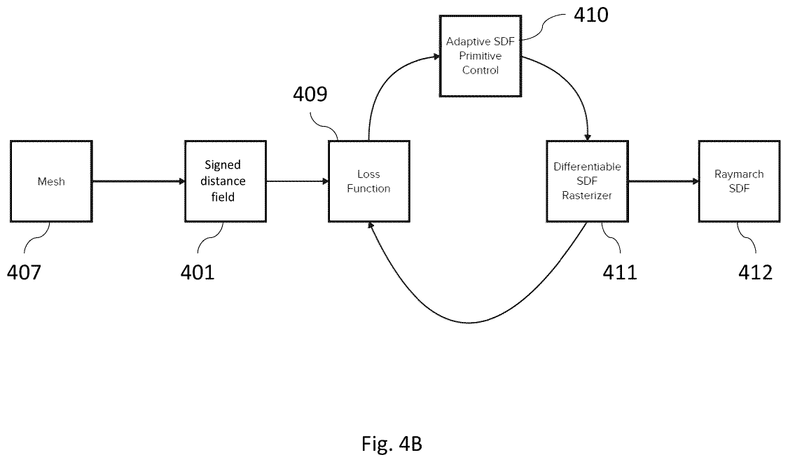

FIG. 4A shows an example method of determining a suitable signed distance function according to the present technology. The method is executed by the processor 202, for example. In this example, a machine learning model 402 is trained using backpropagation to generate one or more parameters of an SDF function which represents the signed distance field associated with the surface of a triangular mesh. The generated SDF thus represents the triangular mesh surface in a compact way which allows the surface to be rendered in a processing and memory efficient manner.

In this example, the machine learning model 402 is a convolutional neural network (CNN) comprising one or more convolutional layers, one or more pooling layers, a flattening layer and an artificial neural network (ANN) (comprising, as an input layer, the flattening layer, one or more fully connected layers and an output layer). The input 401 to the CNN is a set of values of the signed distance field of the surface concerned at each of a plurality of points in 3D space. For instance, the input 401 may take the form of a plurality of matrices with each matrix representing the signed distance field values in a respective plane of the 3D space. The CNN may have a plurality of parallel sets of convolutional and pooling layers (all feeding into the same flattening layer), each set of convolutional and pooling layers being applied to a respective one of the plurality of matrices. The output 403 of the CNN is a vector indicating the value of one or more function parameters of an SDF in a predetermined format intended to represent the signed distance field. This may be referred to as a representative SDF.

The format of the representative SDF function is determined in advance and defines, for example, a combination of one or more simpler, constituent, SDF functions (e.g. one or more SDF functions of a sphere). The combination may include one or more mathematical operations such as add, subtract, union, scale, rotate and/or translate. Thus, to give a very simple example, the representative SDF may be defined as:

$$SDF ( x , y , z ) = min ( α {SDF}_{1} ( x , y , z ) , β {SDF}_{2} ( x , y , z ) , γ {SDF}_{3} ( x , y , z ) ) \qquad Expression 1$$

Here, each of SDF₁, SDF₂ and SDF₃ is a respective constituent SDF function and the representative SDF is the minimum of SDF₁, SDF₂ and SDF₃ scaled with coefficients α, β and γ, respectively. α, β and γ are thus the function parameters of the representative SDF which are determined and output as an SDF vector 403 (in the form [α, β, γ]) by the CNN 402. The SDF function parameters α, β and γ are determined by starting with an initial set of ML parameters 406 of the CNN and generating an initial value of the SDF vector 403 [α, β, γ]. Note that, in contrast to the function parameters α, β and γ, the ML parameters 406 are the usual optimisable parameters of a CNN (including, for example, weights and/or biases of the CNN nodes).

At step 404, the initial values of [α, β, γ] are used to define an initial version of the representative SDF using Expression 1. This is then evaluated at each point (xᵢ, yᵢ, zᵢ) in 3D space for which there is a corresponding value of the signed distance field (here, i=1 to n where n is the number of points of the signed distance field). Backpropagation 405 based on the differences between SDF (xᵢ, yᵢ, zᵢ) and the value of the signed distance field at xᵢ, yᵢ, zᵢ (e.g. using stochastic gradient descent) is then used to update the ML parameters 406. The signed distance field and SDF values are thus, in effect, compared and the ML parameters 406 adjusted to updated the SDF so the signed distance field and SDF values more closely match. The process is repeated over one or more epochs (that is, over all n points of the signed distance field) to find the representative SDF which best represents the signed distance field. In an example, n=300, 500 or 1000. In an example, the number of epochs of stochastic gradient descent may be 1, 3, 5 or 10.

Each SDF for which backpropagation is performed may be referred to as a candidate SDF (and the corresponding values of [α, β, γ] defining that SDF referred to as candidate values). The SDF at the end of the backpropagation process is the final, representative SDF (and the corresponding values of [α, β, γ] defining that SDF may be referred to as final values).

For ease of explanation, the SDF of Expression 1 is a simplified example. In reality, SDF (x, y, z) may have a much larger number of constituent simple SDFs and a much large number of corresponding function parameters (with the CNN 402 thus being configured to output a correspondingly higher dimensional SDF vector 403). For instance, SDF (x, y, z) may comprise constituent SDFs corresponding to respective different shaped surfaces (e.g. sphere, box, torus, cone, etc.) and the function parameters may include, for each constituent SDF, a parameter for the number of each constituent SDF type (e.g. number of sphere SDFs, number of cone SDFs, etc.) and, for each SDF, a scale (as exemplified by function parameters α, β and γ above), rotation and translation of that SDF. Any signed distance field of any triangular mesh surface may thus be sufficiently approximated by the representative SDF by training, for each unique triangular mesh surface, the CNN 402.

Any suitable technique may be used to generate the signed distance field 401 from the triangular mesh surface of a virtual object. In one example, a 3D space comprising the 3D triangular mesh is partitioned into a grid (with the position at the centre of each grid cell being a respective point of the signed distance field). For any triangle of the mesh intersecting a grid cell, the distance from the centre of the grid cell to the closest point on the triangle is determined. This distance is then recorded as the value of the signed distance field for that grid cell. Sweeping is then used to determine the signed distance field values for the remaining grid cells. For each remaining grid cell, the signed distance field value is determined as the signed distance field value of the neighbouring cell closest to the mesh (that is, the neighbouring cell with the lowest magnitude signed distance field value) plus the distance between the cells.

FIG. 4B shows an example flow for determining the representative SDF. A 3D triangular mesh 407 is used to generate a corresponding signed distance field 401. A loss function 409 is then used with the signed distance field 401 and a candidate SDF to adjust the ML parameters 406 of the ML model 402. The adjustment of the ML parameters, in turn, causes the function parameters of the candidate SDF (as represented by SDF vector 403) to be adjusted to bring the candidate SDF into increased conformity with the signed distance field 401. This is illustrated by steps 410 (in which, by adjustment of the function parameters, the constituent SDFs (also known as SDF primitives) of the candidate SDF are adjusted) and 411 (which rasterizes the candidate SDF, i.e. evaluates it at (xᵢ, yᵢ, zᵢ)).

The loss function 409 comprises, for each point (xᵢ, yᵢ, zᵢ), comparing the value of the signed distance field 401 and the value of the candidate SDF. For example, the loss function may be the squared difference between these two values. The ML parameters 402 (and thus function parameters of the candidate SDF) are adjusted using, for example, stochastic gradient descent to minimise the loss function. The rasterized candidate SDF generated at step 411 is differentiable to enable the generation of gradients for use in stochastic gradient descent. Such gradients may be obtained using any suitable known technique such as, for example, stochastic gradient estimation (SGE).

Once all epochs have been completed, the final representative SDF can be used for ray marching (see below) for rendering of the virtual objection concerned (step 412).

In the above example, the number of each type of constituent SDF (e.g. number of sphere SDFs, number of cone SDFs, etc.) of the representative SDF (x, y, z) is a function parameter. In this case, underfill or overfill (explained below) is corrected through the loss function optimisation already described. This may be referred to as correction method 1. For example, if the value of the candidate SDF at a point (xᵢ, yᵢ, zᵢ) is greater than the value of the signed distance field at that point, this is indicative of underfill. On the other hand, if the value of the candidate SDF at a point (xᵢ, yᵢ, zᵢ) is less than the value of the signed distance field at that point, this is indicative of overfill.

Alternatively, an initial format of the representative SDF may assume only one of each type of constituent SDF is required. The initial format of the representative SDF is then adjusted as necessary to include any additional instance(s) of any of the constituent SDF types (together with additional corresponding function parameters for each additional constituent SDF) and/or remove instance(s) of any of the constituent SDF types altogether (together with removing the corresponding function parameters for each removed constituent SDF). This helps appropriately scale the total number of ML parameters that must be determined through backpropagation 405 for a given 3D triangular mesh, thereby providing more efficient use of computational resources. For instance, it allows the total number of ML parameters to be reduced for simpler representative SDFs (which may be represented by at most one of each constituent SDF type) while allowing a higher number of ML parameters for more complicated representative SDFs (which may need to be represented by more than one of at least one constituent SDF type). In this alternative example, the function parameters of the representative SDF in a given format are determined by determining the ML parameters 406 in the way described. If overfill or underfill is detected, the format of the representative SDF is adjusted (e.g. by including or removing an instance of one or more of the constituent SDF types) and the procedure for determining the function parameters of the adjusted representative SDF by determining the relevant ML parameters 406 is repeated. This may be referred to as correction method 2 (and may occur instead of or in addition to correction method 1).

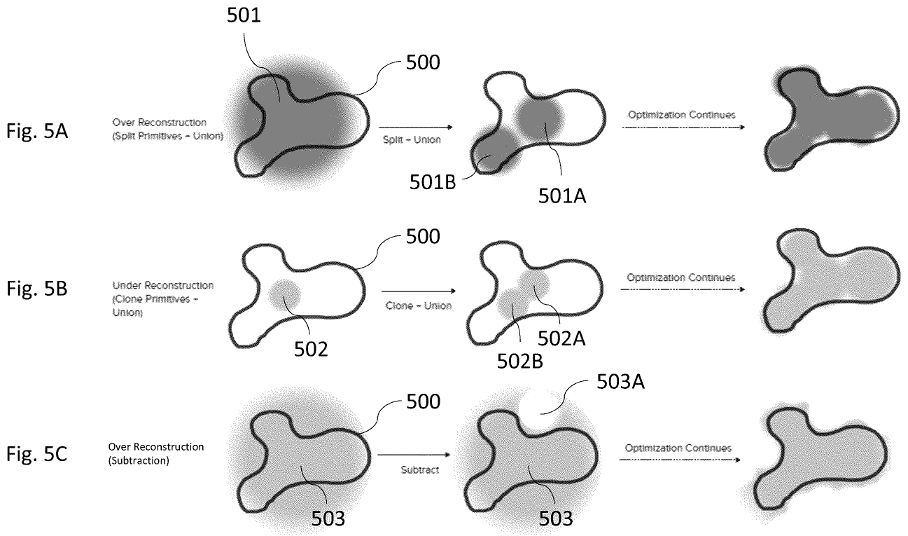

FIGS. 5A to 5C show examples in which the number of instances of each constituent SDF type constituting the representative SDF may be adjusted (e.g. by processor 202) to address overfill or underfill. For ease of explanation, FIGS. 5A 5C show a 2D example. However, it will be appreciated the same principles apply to representative SDFs in 3D space.

FIG. 5A shows an example of over-reconstruction (overfill). Here, the representative SDF initially consists of a single, circular, constituent SDF 501. Due to the shape of the boundary 500, a significant spatial portion outside the boundary is not suitably represented by the SDF. Such spatial portion(s) may be determined as portion(s) outside the boundary for which the SDF is negative, for example (assuming the SDF should be negative within the boundary and positive outside the boundary). In an example, it is determined there is overfill (if not corrected by correction method 1) if evaluation of the representative SDF at more than a predetermined portion (e.g. more than 20, 25 or 30%) of the points in space of the signed distance field outside the boundary are the incorrect sign (e.g. negative when they should be positive).

In the case of overfill, the constituent SDF(s) of the representative SDF are split. In this case, the single constituent SDF 501 is split to generate two constituent SDFs 501A and 501B (each with half the diameter of constituent SDF 501 and with a centre of mass position of constituent SDFs 501A and 501B initially matching the centre of mass position of constituent SDF 501). The format of the representative SDF is thus adjusted to include the two constituent SDFs 501A and 501B (with the necessary additional function parameters). The splitting process is then repeated as necessary (with adjustment of the function parameters of the representative SDF including the additional constituent SDFs) until the resulting representative SDF better represents the boundary 500.

FIG. 5B shows an example of under-reconstruction (underfill). Here, the representative SDF initially consists of a single, circular, constituent SDF 502. However, due to the shape of the boundary 500, a significant spatial portion within the boundary is not suitably represented by the SDF. Such spatial portion(s) may be determined as portion(s) within the boundary for which the SDF is positive, for example (assuming the SDF should be negative within the boundary and positive outside the boundary). In an example, it is determined there is underfill (it not corrected by correction method 1) if evaluation of the representative SDF at more than a predetermined portion (e.g. more than 20, 25 or 30%) of the points in space of the signed distance field within the boundary are the incorrect sign (e.g. positive when they should be negative).

In the case of underfill, the constituent SDF(s) of the representative SDF are cloned. In this case, the single constituent SDF 502 is cloned to generate two constituent SDFs 502A and 502B (with a centre of mass position of constituent SDFs 502A and 502B initially matching the centre of mass position of constituent SDF 502). The format of the representative SDF is thus adjusted to include the two constituent SDFs 502A and 502B (with the necessary additional function parameters). The cloning process is repeated as necessary (with adjustment of the function parameters of the representative SDF including the additional constituent SDFs until the resulting representative SDF better represents the boundary 500.

FIG. 5C shows another example of addressing over-reconstruction (overfill). In this case, rather than splitting the single constituent SDF 503 (as in the example of FIG. 5A), a subtraction operation is performed in which an additional constituent SDF 503A is subtracted from the SDF 503 outside the boundary 500. The format of the representative SDF is thus adjusted to include the two constituent SDFs 503 and 503A (with the necessary additional function parameters). The subtraction process is then repeated as necessary (with adjustment of the function parameters of the representative SDF including the additional constituent SDFs which are subtracted from the original constituent SDF 503) until the resulting representative SDF better represents the boundary 500.

Once a representative SDF has been generated, it may be provided to games console 110 (as part of the data representing a video game) and used by the CPU 20 and/or GPU 30 (with necessary texture data, e.g. partially resident textures, also forming part of the data representing the video game) to render an image of the associated 3D object.

In an example, this is achieved by sphere tracing (an example of ray marching) the representative SDF along a ray for each pixel transformed with respect to the camera. For each pixel on the screen, a point is projected at the near plane ‘n’ and far plane ‘f’ of the virtual camera frustum. The normalised vector between the positions of the projections of the points on ‘n’ and ‘f’ is then determined denoted ‘rv’. The representative SDF is then evaluated at position ‘p’ starting at the projected position on ‘n’. This gives the distance ‘d’ to the closest surface. Assuming the negative and positive convention discussed earlier, if ‘d’ is negative then point p is inside the surface and the pixel can thus be rendered. On the other hand, if ‘d’ is positive then point p is outside the surface. In this case, rv*d is added to p (thereby marching along the ray ‘rv’ by ‘d’ units) and the representative SDF re-evaluated (at p=f+rv*d in this case). This is then repeated as often as required (i.e. until ‘d’ becomes less than a predetermined threshold between the ‘n’ and ‘f’ planes of the virtual camera frustum or until p is outside the virtual camera frustum).

In an example, different representative SDFs can be used for the same object depending on the required LOD (level of detail). For example, for a lower LOD, a simpler representative SDF may be used (e.g. with fewer constituent SDFs and/or constituent SDF types and/or fewer function parameters) whereas for a higher LOD, a more complex representative SDF may be used (e.g. with more constituent SDFs and/or constituent SDF types and/or more function parameters). In an example, a representative SDF suitable for the highest LOD of a particular object may be generated using ML model 402. This can then be downsampled to generate one or more lower LOD representative SDFs. The downsampling may involve, for example, removing one or more of the least significant constituent SDFs (e.g. those with the smallest magnitude scaling coefficient(s) in the combination of constituent SDFs defining the representative SDF). This allows evaluation of the SDF to be completed more quickly and with reduced processing for rendering of objects at a lower LOD. Furthermore, by following a rule such as removing the least significant constituent SDF(s), the generation of different SDFs for different LODs of the same object may be automated.

The present technology thus enables a representative SDF to be automatically generated for the 3D triangular mesh representing the shape of any virtual object. The resulting representative SDF can then be used to render images in a more computationally and memory efficient way than conventional 3D triangular mesh rendering. At the same time, however, since the SDF is generated from a 3D triangular mesh, existing software and hardware for authoring virtual object shapes as 3D triangular meshes may continue to be used. The present technology may thus remain compatible with existing authoring pipelines.

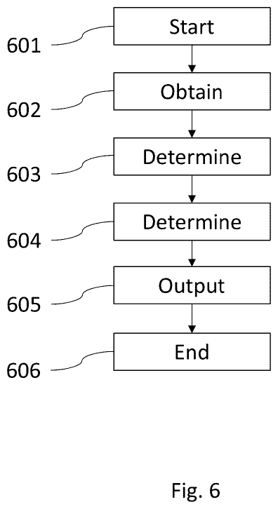

FIG. 6 shows an example method. The method is executed by the processor 202, for example.

The method starts at step 601.

At step 602, data representing a boundary representing a virtual object in a virtual space is obtained.

At step 603, a signed distance field of the boundary in the virtual space is determined.

At step 604, a representative signed distance function representing the signed distance field is determined. This is done by comparing a value of the signed distance field at each of a plurality of points of the virtual space with an output of one or more candidate signed distance functions at each of the plurality of points of the virtual space, a representative signed distance function representing the signed distance field.

At step 605, data representing the representative signed distance function is output.

The method ends at step 606.

Example(s) of the present technique are defined by the following numbered clauses:

1. A data processing apparatus comprising circuitry configured to:
obtain data representing a boundary representing a virtual object in a virtual space;
determine a signed distance field of the boundary in the virtual space;
determine, by comparing a value of the signed distance field at each of a plurality of points of the virtual space with an output of one or more candidate signed distance functions at each of the plurality of points of the virtual space, a representative signed distance function representing the signed distance field; and
output data representing the representative signed distance function.

2. A data processing apparatus according to clause 1, wherein the representative signed distance function is defined by a final value of each of one or more function parameters and each candidate signed distance function is defined by a candidate value of each of the one or more function parameters.

3. A data processing apparatus according to clause 2, wherein the representative signed distance function represents a combination of one or more constituent signed distance functions.

4. A data processing apparatus according to clause 3, wherein the one or more function parameters comprise one or more of a parameter indicating a number of each of a plurality of constituent signed distance function types, a scaling parameter of each constituent signed distance function, a rotation parameter of each constituent signed distance function and a translation parameter of each constituent signed distance function.

5. A data processing apparatus according to clause 3 or 4, wherein the circuitry is configured to:
determine, based on an output of the representative signed distance function, if the representative signed distance function is under reconstructed with respect to the virtual object; and
if the representative signed distance function is determined to be under reconstructed with respect to the virtual object, update the representative signed distance function by cloning one or more of the constituent signed distance functions.

6. A data processing apparatus according to clause 3 or 4, wherein the circuitry is configured to:
determine, based on an output of the representative signed distance function, if the representative signed distance function is over reconstructed with respect to the virtual object; and
if the representative signed distance function is determined to be over reconstructed with respect to the virtual object, update the representative signed distance function by splitting one or more of the constituent signed distance functions.

7. A data processing apparatus according to any one of clauses 3, 4 or 6, wherein the circuitry is configured to:
determine, based on an output of the representative signed distance function, if the representative signed distance function is over reconstructed with respect to the virtual object; and
if the representative signed distance function is determined to be over reconstructed with respect to the virtual object, update the representative signed distance function by introducing an additional constituent signed distance function to be subtracted in the combination of one or more constituent signed distance functions.

8. A data processing apparatus according to any preceding clause, wherein the representative signed distance function is determined using a machine learning model.

9. A data processing apparatus according to clause 8, wherein:
an input to the machine learning model comprises a value of the signed distance field at each of the plurality of points of the virtual space;
an output of the machine learning model comprises a value of each of the one or more function parameters for defining the representative signed distance function; and
the circuitry is configured to:
determine the output of each candidate signed distance function at each of the plurality of points of the virtual space using an output candidate value of each of the one or more function parameters; and
perform back propagation using the output of each candidate signed candidate signed distance function at each of the plurality of points of the virtual space and the value of the signed distance field at each of the plurality of points of the virtual space.

10. A data processing apparatus according to clause 9, wherein the machine learning model is a convolutional neural network.

11. A data processing apparatus according to any preceding clause wherein the virtual space is a three-dimensional, 3D, virtual space and the boundary representing the virtual object is a mesh.

12. A data processing apparatus according to clause 11, wherein the mesh is a 3D triangular mesh.

13. A data processing apparatus according to any preceding clause, wherein the virtual object is a video game object.

14. A computer-implemented data processing method comprising:
obtaining data representing a boundary representing a virtual object in a virtual space;
determining a signed distance field of the boundary in the virtual space;
determining, by comparing a value of the signed distance field at each of a plurality of points of the virtual space with an output of one or more candidate signed distance functions at each of the plurality of points of the virtual space, a representative signed distance function representing the signed distance field; and
outputting data representing the representative signed distance function.

15. A program for controlling a computer to perform a method according to clause 14.

16. A computer-readable storage medium storing a program according to clause 15.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be 5 physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
obtain data representing a boundary representing a virtual object in a virtual space;
determine a signed distance field of the boundary in the virtual space;
determine, by comparing a value of the signed distance field at each of a plurality of points of the virtual space with an output of one or more candidate signed distance functions at each of the plurality of points of the virtual space, a representative signed distance function representing the signed distance field; and
output data representing the representative signed distance function.

2. The data processing apparatus according to claim 1, wherein the representative signed distance function is defined by a final value of each of one or more function parameters and each candidate signed distance function is defined by a candidate value of each of the one or more function parameters.

3. The data processing apparatus according to claim 2, wherein the representative signed distance function represents a combination of one or more constituent signed distance functions.

4. The data processing apparatus according to claim 3, wherein the one or more function parameters comprise one or more of a parameter indicating a number of each of a plurality of constituent signed distance function types, a scaling parameter of each constituent signed distance function, a rotation parameter of each constituent signed distance function and a translation parameter of each constituent signed distance function.

5. The data processing apparatus according to claim 3, wherein the circuitry is configured to:
determine, based on an output of the representative signed distance function, if the representative signed distance function is under reconstructed with respect to the virtual object; and
if the representative signed distance function is determined to be under reconstructed with respect to the virtual object, update the representative signed distance function by cloning one or more of the constituent signed distance functions.

6. The data processing apparatus according to claim 3, wherein the circuitry is configured to:
determine, based on an output of the representative signed distance function, if the representative signed distance function is over reconstructed with respect to the virtual object; and
if the representative signed distance function is determined to be over reconstructed with respect to the virtual object, update the representative signed distance function by splitting one or more of the constituent signed distance functions.

7. The data processing apparatus according to claim 3, wherein the circuitry is configured to:
determine, based on an output of the representative signed distance function, if the representative signed distance function is over reconstructed with respect to the virtual object; and
if the representative signed distance function is determined to be over reconstructed with respect to the virtual object, update the representative signed distance function by introducing an additional constituent signed distance function to be subtracted in the combination of one or more constituent signed distance functions.

8. The data processing apparatus according to claim 1, wherein the representative signed distance function is determined using a machine learning model.

9. The data processing apparatus according to claim 8, wherein:
an input to the machine learning model comprises a value of the signed distance field at each of the plurality of points of the virtual space;
an output of the machine learning model comprises a value of each of the one or more function parameters for defining the representative signed distance function; and
the circuitry is configured to:
determine the output of each candidate signed distance function at each of the plurality of points of the virtual space using an output candidate value of each of the one or more function parameters; and
perform back propagation using the output of each candidate signed candidate signed distance function at each of the plurality of points of the virtual space and the value of the signed distance field at each of the plurality of points of the virtual space.

10. The data processing apparatus according to claim 9, wherein the machine learning model is a convolutional neural network.

11. The data processing apparatus according to claim 1, wherein the virtual space is a three-dimensional, 3D, virtual space and the boundary representing the virtual object is a mesh.

12. The data processing apparatus according to claim 11, wherein the mesh is a 3D triangular mesh.

13. The data processing apparatus according to claim 1, wherein the virtual object is a video game object.

14. A computer-implemented data processing method comprising:
obtaining data representing a boundary representing a virtual object in a virtual space;
determining a signed distance field of the boundary in the virtual space;
determining, by comparing a value of the signed distance field at each of a plurality of points of the virtual space with an output of one or more candidate signed distance functions at each of the plurality of points of the virtual space, a representative signed distance function representing the signed distance field; and
outputting data representing the representative signed distance function.

15. A non-transitory computer-readable storage medium storing a program for controlling a computer to perform a data processing method comprising:
obtaining data representing a boundary representing a virtual object in a virtual space;
determining a signed distance field of the boundary in the virtual space;
determining, by comparing a value of the signed distance field at each of a plurality of points of the virtual space with an output of one or more candidate signed distance functions at each of the plurality of points of the virtual space, a representative signed distance function representing the signed distance field; and
outputting data representing the representative signed distance function.
